(19) United States
(12) Patent Application Publication
(10) Pub. No.: US 2023/0278926 A1
(43) Pub. Date: Sep. 7, 2023

(54) MULTIFUNCTIONAL SUPERPLASTICIZER FOR ULTRA-HIGH PERFORMANCE CONCRETE AND PREPARATION METHOD THEREFOR

(71) Applicants: Sobute New Materials Co., Ltd., Nanjing, Jiangsu (CN); Bote Building Materials (Tianjin) Co.,Ltd., Tianjin (CN)

(72) Inventors: Jiaping LIU, Nanjing (CN); Xin SHU, Nanjing (CN); Qianping RAN, Nanjing (CN); Yong YANG, Nanjing (CN); Tao WANG, Nanjing (CN); Qianqian ZHANG, Nanjing (CN); Jianzhong LIU, Nanjing (CN); Dongliang ZHOU, Nanjing (CN)

(21) Appl. No.: 18/013,266

(22) PCT Filed: Jun. 30, 2020
(86) PCT No.: PCT/CN2020/099415

§ 371 Date: May 24, 2023

(30) Foreign Application Priority Data
Jun. 29, 2020 (CN) 202010609909.2

(51) Int. Cl. C04B 24/24; C08F 283/08; C08F 290/06

(52) U.S. Cl. CPC C04B 24/246; C08F 283/08; C08F 290/062; C04B 2103/32; C08F 2810/40

(57) ABSTRACT

Providing a multi-functional group superplasticizer for an ultra-high performance concrete and a method for preparing the same. Its backbone is an alkyl chain, and its side chain are some side chains with carboxylic acid or carboxylate at terminals, some polyether side chains, and some polyol amine side chains substituted with phosphoric acid or phosphite at terminals, the polyol amine side chains substituted with phosphoric acid or phosphite at terminals is connected to the backbone through a phenyl or an alkyl group of 1-9 carbons, and a ratio of a number of the side chains with carboxylic acid or carboxylate at terminals to a total number of side chains is ≥0 and ≤0.8; and a ratio of a number of the polyether side chains to the total number of side chains is ≥0.1 and ≤0.9.

### CROSS REFERENCE TO RELATED APPLICATION

The present application claims the benefit of a priority to Chinese Patent Application entitled with “MULTI-FUNCTIONAL GROUP SUPERPLASTICIZER FOR ULTRA-HIGH PERFORMANCE CONCRETE AND METHOD FOR PREPARING THE SAME”, filed on Jun. 29, 2020, the content of which is incorporated herein by reference in its entirety.

### TECHNICAL FIELD

The present application relates to the field of concrete superplasticizer, in particular, to a superplasticizer for an ultra-high performance concrete, and a method for preparing the same.

### BACKGROUND

A term “concrete” used here often refers indiscriminately to a concrete such as beton, mortar, or grouting, which are also applied elsewhere herein.

A high performance water reducing agent (especially polycarboxylate water reducing agent or polycarboxylate superplasticizer) has been widely used and greatly developed since it is invented, which has become an essential component in concrete. Generally, the polycarboxylate water reducing agent has a comb structure, generally prepared by a vinyl-containing monomer through free radical polymerization, its backbone (generally —CH₂—CH₂— structure or —CH₂—CH₂— structure substituted by a functional group) is connected with a charged functional group (such as carboxyl group, sulfonic acid group, etc.), and corresponding side chain is mainly water-soluble polyether side chain, and in the concrete, they are adsorbed thereon through electrostatic interaction between the charged functional group and surface of cement particles, while corresponding long side chain prevents the cement particles from coming close to each other and agglomerating through steric hindrance (repulsion action), releasing the enclosed moisture, improving workability of the concrete, and reducing water-cement ratio.

Ultra-high performance concrete (compressive strength of 100 MPa or more) has attracted wide attention due to its excellent service performance. However, its water-binder ratio is extremely low, generally not greater than 0.2. A content of ultra-fine powder having solid particle with hydration activity, such as silica fume, ultra-fine mineral powder, and so on, in its cementing material component is extremely high, often reaching 30% or even 40% of the total mass of cementing material. The size of the ultra-fine powder is generally in a nanometer range (10¹ nm-10⁰ µm), which is smaller than the size of cement particles (about 10¹ µm), so that the ultra-high performance concrete has poor fluidity and high viscosity compared with coventional commercial concrete, which becomes one of key problems restricting construction. In addition, the ultra-fine powder has different interface characteristic from the cement particles. In a concrete slurry solution environment, conventional polycarboxylate superplasticizer for cement has designed for insufficient adsorption affinity of these particles, and has poor versatility and insufficient performance in a complex cementing material system of ultra-high performance concrete, which is difficult to meet its basic requirements for fluidity and low viscosity.

In view of such a problem, people have developed a large number of new technologies of a water reducing agent to reduce water-binder ratio of concrete, reduce shear resistance and improve workability.

A design scheme of EP1775271A2 for water reducing agent can reduce viscosity of concrete and have good slump protection performance, but it is designed for coventional concrete and is difficult to be applied in high/ultra-high strength concrete.

CN106467604A reported copolymerizing an unsaturated carboxylic acid ester monomer and an unsaturated phosphate ester monomer having bifunctionality with an unsaturated anhydride and a polyether monomer to prepare a viscosity reducing polycarboxylate water reducing agent.

CN103553413A disclosed a viscosity adjustment water reducing agent by introducing a viscosity adjustment monomer (unsaturated alkyl ester, fluoride-containing ester, alkyl acrylamide or its concrete), which can effectively reduce the viscosity of concrete, but it has air guide function to some degree.

CN106431060A reported a solution of a viscosity reducing polycarboxylate water reducing agent for high strength concrete by compounding a water reducing agent, a viscosity reducing agent, and a slump preserving agent, which can reduce the viscosity of high strength concrete to some degree.

CN10147533 disclosed an early strength polycarboxylate compounding water reducing agent by using a compounding viscosity reducing component polyethylene glycol, which significantly reduces the viscosity of concrete to meet the fluidity requirements of concrete construction process.

CN103865007A disclosed a method for preparing a viscosity reducing polycarboxylate water reducing agent by introducing and controlling a certain amount of hydrophobic units and hydrophobic groups into a molecular structure of carboxylic acid copolymer, which can reduce the viscosity of cement-based materials under the action of the water reducing agent, and have superior performances.

CN105367721A disclosed a method for preparing a viscosity reducing polycarboxylate superplasticizer and its use, monomer b containing branch side chain and monomer c containing rigid ring group for free radical polymerization are mainly introduced in the structure, so that it can greatly reduce the water-binder ratio of concrete and effectively reduce the viscosity of concrete.

CN106397683A reported a polycarboxylate water reducing agent for reducing the viscosity of high grade concrete and its preparation method, after free radical polymerization of terminal vinyl polyoxyethylene ether, unsaturated acid (benzenesulfonic acid, benzoic acid, acrylic acid, etc.), unsaturated ester (unsaturated hydroxyl ester), it was prepared through molecular arrangement by using a viscosity reducing regulator, and it has high water reduction rate and good viscosity reduction effect.

CN104262550A disclosed a method for preparing a viscosity reducing polycarboxylate water reducing agent, in which an unsaturated primary amine small monomer, organic small molecules with epoxy groups, and halogen-containing groups are used to prepare an unsaturated quaternary ammonium salt, and then copolymerized with an unsaturated acid, the preparation of the viscosity reducing polycarboxylate water reducing agent has a simple reaction and is easy to be controlled, which can effectively reduce the viscosity of concrete.

CN104371081A disclosed a method for preparing a rapid dispersion and viscosity reducing polycarboxylate cement dispersant, in which an unsaturated monomolecular monomer containing tertiary amino group is used as a reducing agent that can participate in polymerization to obtain a hyperbranched polycarboxylate cement dispersant, which can greatly improve the viscosity of concrete.

CN106008784A reported a concrete viscosity reducing agent prepared by polymerization of 4-hydroxybutyl vinyl polyether, unsaturated amide and unsaturated phosphate, which can reduce the viscosity of concrete without affecting its fluidity, and improve pumping construction performance.

CN105837740B reported a concrete viscosity regulator, which is a ternary copolymer obtained by free radical polymerization of a monomer prepared by glycidyl methacrylate and iminodiacetic acid, acrylic acid/methacrylic acid and a cationic monomer, which effectively reduces the viscosity of C50 concrete.

CN105732911B reported a viscosity reducing polycarboxylic acid prepared by polymerization of an unsaturated acid, an unsaturated polyether macromonomer and N-(4-vinyl benzyl)-N,N-dialkylamine, the reaction is simple, the preparation is easy, it has a high water reduction rate, so that it can be used for reducing viscosity of high strength (about 0.3) concrete.

CN100402457C published an admixture of polycarboxylate concrete prepared by free radical polymerization of an alkyl (methyl) acrylate monomer, specific polyalkylene glycol unsaturated macromonomer and an unsaturated acid monomer. Introduction of a third monomer alkyl acrylate monomer with hydrophobic effect can effectively help the water reducing agent to reduce the yield stress and viscosity of concrete.

CN105367721B reported a method for preparing a viscosity reducing polycarboxylate superplasticizer and its application. The superplasticizer adopts a branched side chain polyether to increase a thickness of water film, and introduces other monomers having a rigid ring such as vinyl pyrrolidone to increase the stretching degree of molecular conformation, thereby greatly reducing the viscosity of high or ultra-high strength concretes.

CN104973817B reported a concrete viscosity regulator for using with a water reducing agent, the concrete viscosity regulator is mainly compounded by a clay stabilizer, an air entraining agent, a foam stabilizer and a thickener, which can reduce ineffective adsorption of the water reducing agent, stabilize bubbles, be suitable for C30-C50 concretes, and improve workability.

CN104031217B reported a loose anti-adhesion type high performance polycarboxylate admixture, which is prepared by aqueous solution polymerization of an ester or ether type monomer, an unsaturated carboxylic monomer, an organic phosphate compound and an acrylic acid-lignin polymer, which can enhance adsorption of water molecules, and effectively reduce the viscosity of high strength concrete.

CN109535341A reported a polycarboxylate superplasticizer prepared by a polyethylene glycol with terminal hydrophobic modification, which has excellent viscosity reducing ability. Patent CN108623756A reported a polycarboxylic acid prepared by polymerization of N-ethyl perfluorooctyl sulfonamide acrylate, which can be used in ultra-high performance concrete. However, according to research of the inventor, the terminal hydrophobic modified functional group greatly affects adsorption conformation of the polymer, thus affecting its steric hindrance, especially in the cement-based materials with very low water-binder ratio, and thereby limiting its dispersion ability.

According to the inventor’s research, the fluidity of concrete depends on the fluidity of its slurry, and its viscosity is positively correlated with the viscosity of the slurry, the higher the viscosity of the slurry, the greater the operational resistance such as shear viscosity of concrete. Under the condition that a matching ratio of an aggregate, a cementing material and a water-binder ratio is fixed, the fluidity of slurry is closely related to nano-micron particles with a size of 10¹ nm-10² µm, including cement, ultra-fine powder, mineral admixtures and stone powder. The water reducing agent is adsorbed to the particle surface through adsorption action, which can effectively disperse the particles and increase the fluidity. Slurry viscosity reflects the resistance generated by slurry shear, which is determined by mutual friction between nano-micron particles in the slurry. Surface coverage of particles by polymer can effectively weaken mutual friction between particles, thus reducing the viscosity.

A coventional water reducing agent has a weak adsorption effect on the surface of nano-micron particles such as silica fume and so on, which cannot effectively cover surfaces of all powder particles. In general concrete, the water-binder ratio is high, the content of nano-micron particles such as silica fume in the slurry is relatively low, and the general water reducing agent has good application performance. However, in ultra-high performance concrete, the water-binder ratio is extremely low, and the content of nano-micron particles is extremely high. Whether the water reducing agent can adsorb to surfaces of particles has a very significant impact on the fluidity and viscosity. At this time, the coventional water reducing agent shows insufficient performance, low fluidity of concrete, low friction weakening between particles, high viscosity of slurry, and difficult construction.

However, the above existing new technologies (products of water reducing agent) fail to fundamentally address the problems. These water reducing agents have not been specially designed, and their surface adsorption to nanoparticles such as silica fume and the like is weak, and they cannot effectively cover surfaces of all particles. Therefore, the slurry has many flocculation structures, poor fluidity and high viscosity, and effect of the water reducing agent is very limited. The water-binder ratio of concrete reported is mostly between 0.2 and 0.35, which belongs to conventional high-strength concrete, and is rarely related to ultra-high strength concrete.

### SUMMARY

In order to solve the problems of poor dispersion ability, low water reduction rate and insufficient viscosity reduction effect of conventional water reducing agent in ultra-high performance concrete, the present application provides a new structural superplasticizer and a preparation method thereof. The superplasticizer is comprehensively enhanced adsorption ability, so that particle friction is weakened, thereby significantly improving the fluidity of ultra-high performance concrete and reducing its viscosity compared to the related art.

A backbone of the multi-functional group superplasticizer is an alkyl chain, and its side chain are some side chains with carboxylic acid or carboxylate at terminals, some polyether side chains, and some polyol amine side chains substituted with phosphoric acid or phosphite at terminals. The polyol amine side chains substituted with phosphoric acid or phosphite at terminals is connected to the backbone through a phenyl or an alkyl group of 1-9 carbons. A ratio of a number of the side chains with carboxylic acid or carboxylate at terminals to a total number of side chains is >0 and <0.8; and a ratio of a number of the polyether side chains to the total number of side chains is >0.1 and <0.9.

Following two structural formulas of the polyol amine side chains substituted with phosphoric acid or phosphite are combined in any proportion:

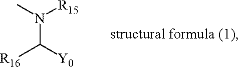

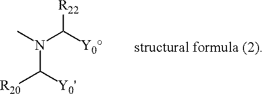

In the structure shown, R₁₅ represents H or a saturated alkyl group containing 1-4 carbon atoms, in a same polymer molecule, R₁₅ can be the same or different in the structure shown in each chain.

In the structure shown, R₁₆, R₂₀ and R₂₂ independently represent —PO₃H₂ or —PO₂H₂.

In the structure shown, Y₀, Y₀’ and Y₀” are product functional groups of the polyols containing hydroxyl group reacting with sufficient or insufficient amount of phosphorylation reagent, such that H of the hydroxyl is substituted with phosphoryl group, and Y₀, Y₀’ and Y₀” are connected to the structural formula through a carbon-carbon bond; an original structure of the polyol containing hydroxyl may have a carboxyl group or may originally contain a phosphoryl group.

The phosphorylation reagent is a conventional phosphorylation reagent in the related art. (hereafter, J is used to refer to it).

As an improvement, Y₀, Y₀’ and Y₀” in the structure shown are alkyl polyol residues connected with carboxyl, carboxylate, phosphoryl or phosphate functional groups at terminals, and Y₀, Y₀’ and Y₀” are connected to the remaining structure shown in structural formula (2) by a carbon-carbon bond; or alkyl polyol residues substituted in part or in whole with carboxyl, carboxylate, phosphoryl or phosphate functional groups; and carboxyl group replaces the position of H atom of C—H bond, and the phosphoryl group replaces the position of H of C—H bond or hydroxyl group.

As an improvement, Y₀, Y₀’ and Y₀” in the structure shown independently represent any one or more of the structure shown in following general Formula (3). In a same polymer molecule, Y₀, Y₀’ and Y₀” in the structures shown by each chain can be the same or different respectively, where chirality of all carbon atoms can be arbitrary:

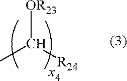

where R₂₃ represents H or —PO₃H₂ or any one or more of functional groups shown in general Formula (4) below, R₂₄ represents H or —CH₂OPO₃H₂ or —COOH or —COONa or —COOK or —CH₂OPO₃Na₂ or —CH₂OPO₃K₂, x₄ represents a positive integer between 2-6, and comprising 2 and 6; each of Y₀, Y₀’ and Y₀” functional groups can respectively have at most one functional group as shown in general Formula (4),

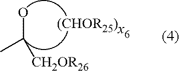

where R₂₅ and R₂₆ independently represent H or —PO₃H₂, and x₆ represents a positive integers between 1 and 4, and comprising 1 and 4.

As a further improvement, the side chain with carboxylic acid or carboxylate at terminals is any one of following structural formulas:

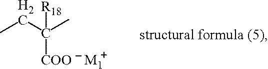

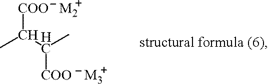

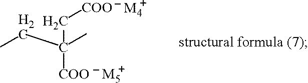

where R₁₈ represents H or methyl,
M1⁺, M2⁺, M3⁺, M4⁺, and M5⁺ independently represent H⁺ or NH4⁺ or Na⁺ or K⁺, respectively.

The polyether segment is connected to the backbone by carbonyl, phenyl, —OCH₂CH₂—, —OCH₂CH₂CH₂—, —CO—NH—CH₂CH₂ —, or —(CH₂)ₚₚ—, where pp is an integer between 1 and 6, and comprising 1 and 6.

The multi-functional group superplasticizer is a comb polymer having a structure shown in following general formula (8), in which chirality of all carbon atoms is not limited:

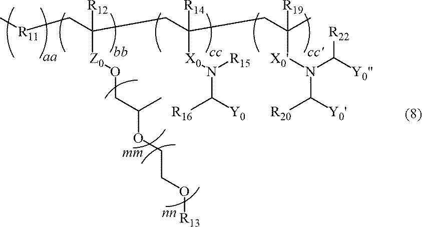

in the structure shown, an average number of R₁₁ segment is aa;
in the structure shown, R₁₂, R₁₃, R₁₄ and R₁₉ independently represent —H or methyl, respectively;
in the structure shown, Z₀ represents carbonyl or phenyl or —OCH₂CH₂— or —OCH₂CH₂CH₂CH₂— or —CO—NH—CH₂CH₂ — or —(CH₂)ₚₚ—, where pp is an integer between 1 and 6, and comprising 1 and 6;
in the structure shown, mm and nn represent a number of repeat units of isopropoxy and ethoxy, respectively, which can be an integer or not, a value of (mm+nn) ranges from 8 to 114, and mm/(mm+nn) is not greater than ½, so as to ensure the water solubility of polyether and the extensibility of its molecular chain in aqueous solution. The structure shown in general formula (0) does not limit a connection order of ethoxy and isopropoxy repeat units, which can be block or random;
in the structure shown, X₀ and X₀’ independently represent saturated alkyl containing 1-9 carbon atoms or phenyl, respectively;
R₁₅ represents H or a saturated alkyl group containing 1-4 carbon atoms, in a same polymer molecule, R₁₅ can be the same or different in the structure shown by each chain;
in the structure shown, R₁₆, R₂₀ and R₂₂ independently represent —PO₃H₂ or —PO₂H₂ or the corresponding sodium salt and potassium salt, respectively; and
in the structure shown, aa, bb, cc and cc′ respectively represent an average of the corresponding chains of the polymer, and a ratio of cc to cc′ is arbitrary, the values of aa, bb, cc and cc′ should meet following conditions: (1) 0≤aa/(aa+bb+cc+cc′)≤0.8; (2) 0.1≤bb/(aa+bb+cc+cc′)≤0.9; and (3) a weight average molecular weight of the superplasticizer polymer ranges from 2000 to 100000.

In the method for preparing the multi-functional group superplasticizer in the present application, copolymerizing terminal alkenylamine B, polyhydroxyaldehyde C and phosphorous-containing composition E under an environment of solvent A and the action of acid catalyst D, to obtain an intermediate, and free radical polymerizing with unsaturated carboxylic acid F and unsaturated polyether G in aqueous solution to produce the multi-functional group superplasticizer.

The solvent A is any one of water, dimethyl sulfoxide, N,N-dimethyl formamide, N,N-dimethyl acetamide, N-methyl pyrrolidone, and dioxane, or a mixture thereof at any proportion.

The terminal alkenylamine B is any one of a structure corresponding to following general formula (9), and corresponding hydrochloride and sulfate, or an arbitrary mixture of more than one thereof:

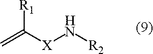

where R₁ represents —H or methyl, X represents a saturated alkyl containing 1-9 carbon atoms or phenyl, and R₂ represents H or a saturated alkyl containing 1-4 carbon atoms.

The polyhydroxyaldehyde C is any one of a small molecular sugar with an aldehyde terminal group containing 3-14 carbon atoms, or an organic molecule corresponding to the structure shown in following general Formula (10), or an arbitrary mixture of more than one thereof:

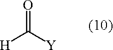

where Y represents any one of the structures shown in following general Formula (11), where the configuration of any chiral carbon atom is not limited:

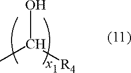

where R₄ represents any one of H or —CH₂OPO₃H₂ or —COOH or —COONa or —COOK or —CH₂OPO₃Na₂ or —CH₂OPO₃K₂ or following structures shown in general Formula (12);

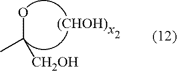

x₁ is a positive integer between 2 and 6, and comprising 2 and 6; x₂ represents a positive integer between 1 and 4, and comprising 1 and 4.

The acid catalyst D is a strong acid, comprising but not limited to any one of p-toluene sulfonic acid, hydrochloric acid, sulfuric acid, trifluoroacetic acid, methyl sulfonic acid, trifluoromethanesulfonic acid, sodium bisulfate, potassium bisulfate and ammonium bisulfate.

The phosphorous-containing composition E is a mixture of component I and component J, where the component I is one of phosphorous acid, potassium dihydrogen phosphite, sodium dihydrogen phosphite, hypophosphorous acid, sodium hypophosphite and potassium hypophosphite, or an arbitrary mixture of more than one thereof, and component J is one of phosphoric acid, polyphosphate, pyrophosphoric acid, phosphorus penoxide and water, or a mixture of more than one thereof.

The component I is reacted with aldehyde group of B and C; J is reacted with hydroxyl group of C, and amounts of I and J are determined by amount of B and content of hydroxyl group in C.

The component J is a mixture prepared by reacting anhydride of phosphoric acid with water, which cannot be purified and separated, and has reactivity.

The unsaturated carboxylic acid F is one of acrylic acid, methacrylic acid, maleic acid, fumaric acid, maleic anhydride, fumaric anhydride, itaconic acid or corresponding sodium, potassium and ammonium salts thereof, or a mixture of more than one thereof.

The unsaturated polyether G is one or a combination of more than one of the structures shown in following general Formula (13) :

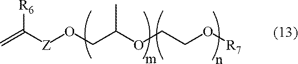

where R₆ and R₇ independently represent —H or methyl, Z represents carbonyl, phenyl, —OCH₂CH₂—, —OCH₂CH₂CH₂—, —CO—NH—CH₂CH₂ —, or —(CH₂)ₚ—, where p is an integer between 1 and 6, and comprising 1 and 6; and
m and n represent a number of repeated units of isopropoxyl and ethoxyl, respectively, which can be an integer or not, values of (m+n) ranges from 8 to 114, and m/(m+n) is not greater than ½, so as to ensure the water solubility of polyether and the extensibility of its molecular chain in aqueous solution. The structure shown in general formula (13) does not limit a connection order of ethoxy and isopropoxy repeat units, which can be block or random.

The value of (m+n) reflects the length of the side chain. If the value of (m+n) is excessively small, the side chain will be short, which does not mean that the dispersant with this structure cannot be prepared, but because the short side chain will lead to poor dispersion performance. If the value of (m+n) is excessively high, preparation difficulty of the plasticizer itself will be increased, the reaction efficiency will be difficult to improve, and the conversion rate will be low. In addition, an excessively long side chain may cause the adsorption groups to be shaded by the side chain, to some extent, it is not conducive to improving the adsorption ability on the surface of solid particles.

The initiator H is a conventional radical polymerization initiation system adopted by those skilled in the art. The initiator can be a heat-initiated or redox initiator, and the initiator can be added at a time or continuously and uniformly within a certain period of time. The initiator must meet following conditions: the initiator can dissolve in the solvent at a corresponding temperature and successfully initiate polymerization, and the initiator is fully decomposed during the reaction process to prevent the change after the reaction from affecting the stability of the polymer.

The initiator in the present application includes but is not limited to the initiator systems listed below.

The heat initiator is any one of azo-diisobutyronitrile, azodiisoheptanitrile, azo-diisobutyamidine hydrochloride, azo-diisobutyimidazoline hydrochloride, ammonium persulfate, potassium persulfate and sodium persulfate;

the redox initiator is composed of an oxidizing agent and a reducing agent, and the oxidizing agent is any one of hydrogen peroxide, ammonium persulfate, potassium persulfate and sodium persulfate;

when the oxidizing agent is hydrogen peroxide, the reducing agent can be one or an arbitrary combination of more than one of saturated alkyl thiol containing 2-6 carbon atoms, thioglycolic acid, ascorbic acid or mercaptopropionic acid. In addition, one or an arbitrary combination of more than one of ferrous acetate, ferrous sulfate or ammonium ferrous sulfate can be comprised or not as a catalyst, which is measured by a molar amount of Fe element, the amount of the catalyst is not greater than 10% of the molar amount of the reducing agent. Excessive amount of catalyst may cause out of control of the molecular weight of polymer.

When the oxidizing agent is any one of ammonium persulfate, potassium persulfate and sodium persulfate, the reducing agent is any one of following compositions: (1) one or an arbitrary combination of more than one of thioglycolic acid, ascorbic acid, rongalite or mercaptopropionic acid, in addition, one or an arbitrary combination of more than one of ferrous acetate, ferrous sulfate or ammonium ferrous sulfate can be comprised or not as a catalyst, which is measured by a molar amount of Fe element, the amount of the catalyst is not greater than 10% of the molar amount of the reducing agent, excessive amount of catalyst may cause out of control of the molecular weight of polymer; (2) one or an arbitrary combination of more than one of sodium bisulfite, sodium sulfite and sodium metabisulfite.

The amount of the initiator is calculated based on following method, if the initiator is a thermal initiator, a mass of the initiator accounts for 0.2% to 4% of a total mass of terminal alkenylamine B, unsaturated carboxylic acid F and unsaturated polyether G; and if the initiator is a redox initiator, by calculating with the one which having more molar amount of oxidant and reductant, a molar amount of the initiator accounts for 0.2% to 4% of a total molar amount of terminal alkenylamine B, unsaturated carboxylic acid F and unsaturated polyether G, and a molar ratio of the oxidizing agent and the reducing agent is 0.25 to 4.

The chain transfer agent K is a conventional free radical polymerization chain transfer agent adopted by those skilled in the art, which is only used to regulate the molecular weight of the product superplasticizer, so that the weight average molecular weight of the product superplasticizer is between 2000 and 100000.

The chain transfer agent K used includes but is not limited to: (1) an organic small molecule containing a sulfhydryl, which includes but is not limited to, a saturated alkyl sulfhydryl containing 2-6 carbon atoms, mercaptoethanol, mercaptoethylamine, cysteine, mercaptoacetic acid or mercaptopropionic acid; (2) sodium bisulfite, sodium sulfite and sodium metabisulfite. Its amount can be regulated according to the target molecular weight of the product, generally can be 0.1% to 15% of a total molar amount of polymerizable double bonds in a reaction system. The total molar amount of the polymerizable double bond is numerically equivalent to a total molar amount of the terminal alkenylamine B, the polyether G and the unsaturated carboxylic acid F.

The method for preparing the superplasticizer in the present application includes following steps:
(1) adding solvent A to a reactor, and adding terminal alkenylamine B, polyhydroxyaldehyde C, and acid catalyst D in sequence, adjusting the reactor to 70° C. to 120° C., stirring uniformly and reacting for 1 h to 12 h, adjusting the reactor to 60° C. to 120° C., adding phosphorus-containing composition E, stirring for 1 h to 12 h, and finishing reaction, and removing the solvent by vacuum to obtain an intermediate mixture; and
(2) radical polymerizing whole intermediate mixture prepared in step (1) with the unsaturated carboxylic acid F and the unsaturated polyether G in aqueous solution under 0° C. to 90° C. to prepare the multi-functional group superplasticizer.

The intermediate mixture, the unsaturated carboxylic acid and the unsaturated polyether can be added in one time, in batches, or continuously and uniformly in a period of reaction time before or during the reaction process. The initiator can be added in one time, in batches, or continuously and uniformly in a period of reaction time before or during the reaction process. The reaction starts from adding the initiator, reacts for a period of time and stops to obtain a solution of the required polymer superplasticizer.

In step (1), the reaction temperature of the first stage is 70-120° C., and the reaction time is 1-12 h. In step (1), the reaction temperature of the second stage is 60-120° C., and the reaction time is 1-12 h. The reaction time required for each step depends on the reaction rate and conversion rate, and the reaction time is generally longer under low temperature.

The reaction temperature in step (2) is 0° C.-90° C., and a cumulative reaction time is 1-12 h since the initiator is added. Similarly, the reaction temperature of this step depends on the initiation system used. Generally, the reaction temperature is relatively low when the redox initiation system is used. Due to the high generation rate of free radical, the reaction rate is fast and the reaction time is short. With thermal initiation, the temperature is relatively high and the reaction time is long. Those skilled in the art can make their own adjustments according to their experience.

An effective reactant in step (1) accounts for 50 to 90% of the total mass of the system, and the effective reactant includes terminal alkenylamine B, polyhydroxyaldehyde C and phosphorous-containing composition E.

A concentration of effective reactant in step (2) is a conventional concentration of the free radical polymerization system used by those skilled in the art, which can be regulated according to the economy, monomer feeding sequence, etc., the typical concentration range of the effective reactants is 30-80 wt%. The effective reactant is a sum of the intermediate mixture, the polyether G and the unsaturated carboxylic acid F.

The terminal alkenylamine B is calculated as the molar amount of H atom connected by N atom, and a molar ratio n(B)/n(C) of which and polyhydroxyaldehyde C ranges from 0.8 to 1.2. If the amount of polyhydroxyaldehyde C is higher than this proportion, the reaction of steps (1) and (2) could be carried out as before, without significantly adversely affected, but it is remained in the final product superplasticizer, which may have obvious retarding characteristics in application, so it was limited here.

A ratio of the amount of active protons (strongly ionized hydrogen ions) in acid catalyst D and a molar amount of terminal alkenylamine B (calculated by the molar amount of H atoms connected by N atoms) ranges from 0.5 to 2.0. Both excessive high and excessive low acid amount are not conducive to improving the conversion rate of the reaction in step (1).

The amount of component I in step (1) is calculated by the molar amount of the phosphorus element, and a ratio of its total amount to the molar amount of the polyhydroxyaldehyde C is 1-2. A ratio of hypophosphorous acid to phosphorous acid in component I is arbitrary, and the amount of hypophosphorous acid or phosphorous acid in component I can be zero.

The mole amount of hydrogen element in component J is denoted as n(J-H), the mole amount of phosphorus element is denoted as n(J-P), and the number of active sites for effective reaction is calculated as [1.5×n(J-P)-0.5×n(J-H)], the amount of component J should meet following conditions at the same time: 1<n(J-H)/n(J-P)<3, and a ratio of [1.5×n(J-P)-0.5×n(J-H)] to n(OH) ranges from 0.2 to 1.2, where n(OH) is a total number of hydroxyl groups in polyhydroxyaldehyde C. A limitation 1≤n(J-H)/n(J-P)≤2.5 is to ensure the reaction activity of component J. If it is higher than this value, the activity is excessive low, and if it is lower this value, it is easy to produce by-products. In addition, if the ratio of [1.5×n(J-P)-0.5×n(J-H)] to n(OH) is excessive low, lesser active functional groups is adsorbed in the intermediate mixture, and if the ratio is excessive high, by-products is also produced, which is not conducive to the polymerization reaction of step (2) since the molecular weight is difficult to control.

The amount of unsaturated carboxylic acid F in step (2) is equivalent to 0-80% of the total molar amount of the terminal alkenylamine B, the unsaturated carboxylic acid F and the polyether G. The amount of unsaturated carboxylic acid F should not be excessive high, otherwise the content of the characteristic adsorption group (connected to the molecule of the superplasticizer through terminal alkenylamine B) in the product superplasticizer is excessive low, and its adsorption ability on the surface of the electronegative powder is limited, and its dispersion ability and economy cannot show advantages in ultra-high performance concrete.

The amount of the polyether G in step (2) is equivalent to 10%-90% of the total molar amount of the terminal alkenylamine B, the unsaturated carboxylic acid F and the polyether G. If the value is excessive high, the adsorption ability of the product superplasticizer is weak; if the value is excessive low, the steric hindrance provided after adsorption is small. In addition, fast loss of early fluidity of concrete may be generated by the excessive strong adsorption ability.

Compared with the commercial conventional superplasticizer, the superplasticizer in the present application can be applied to the ultra-high performance concrete (water-binder ratio not higher than 0.2) according to Examples. Its amount of the present superplasticizer can be reduced by 16-42% compared with the conventional commercial polycarboxylate superplasticizer, and viscosity can be effectively reduced, and shear viscosity can be reduced by 17-42%. In addition, the maximum dispersion ability of the superplasticizer described in the present application is significantly better than that of the commercial superplasticizer, and it can effectively improve the fluidity of concrete under the condition of very low water-binder ratio (usually not higher than 0.16), while the commercial superplasticizer cannot achieve the effective fluidity of concrete regardless of the amount. It should be noted that the required amount of the superplasticizer in the present application to achieve the same fluidity in the conventional commercial concrete may be increased compared with that of commercial superplasticizer.

### DESCRIPTION OF EMBODIMENTS

In order to better understand the present application, the contents of the present application are further described in combination with Examples below, but are not limited to following Examples. The units used below are all part by mass, and all compounds used are commercial products or synthetic products as reported in literatures.

A solvent A, a terminal alkenylamine B, a polyhydroxyaldehyde C, an acid catalyst D, a polyether G (except G3 and G6), an unsaturated carboxylic acid F, a initiator H and a chain transfer agent K are all commercial sources (J&K reagent, TCI reagent, Sigma-Aldrich, Huntsman and RON reagent, etc.). Some polyethers are industrial products, prepared by anionic ring-opening polymerization of ethylene oxide catalyzed by terminal alkenyl alcohol base, which is produced by Subert Company.

TABLE 1

Names of compounds used in Examples

| | |
|---|---|
| B1 | 2-methylallyl amine |
| B2 | 1-amino-10-undecene |
| B3 | allylamine hydrochloride |
| B4 | N-methyl-5-hexene-1-amine |
| B5 | N-ethyl methyl propenyl amine |
| B6 | 4-aminostyrene |
| C1 | DL-glyceraldehyde |
| C2 | D-(+)-glucose |
| C3 | maltose |
| C4 | D-ribose |
| C5 | D-glucose-6-sodium phosphate |
| C6 | glucuronic acid |
| G1 | polyethylene glycol monomethyl ether methacrylate, number average molecular weight of 500, n≈10 |
| G2 | methylallyl polyethylene glycol ether, number average molecular weight of 2400, n≈53 |
| G3 | vinyl polyethylene glycol ether, number average molecular weight of 4000, n≈90 |
| G4 | acrylamide poly (ethoxy-isopropyl) monomethyl ether, number average molecular weight of 2050, m/(m+n)=0.3, and m+n≈4 |
| G5 | 7-octenyl polyethylene glycol ether, number average molecular weight of 3000, n≈65 |
| G6 | acrylamide polyethylene glycol monomethyl ether, number average molecular weight of 5050, n≈113 |

The structures of compounds listed in Table 1 are as follows, and chirality of some compounds is not labeled:

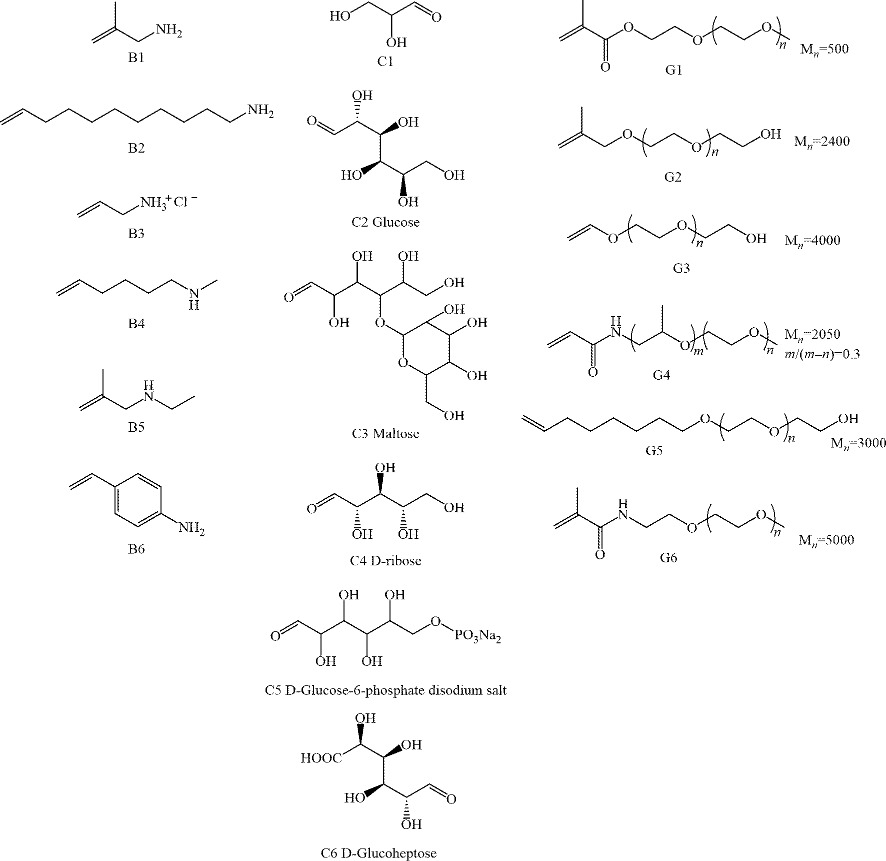

Polyethers G3 and G6 were prepared by dehydration and condensation of corresponding polyethylene glycol or substituted polyethylene glycol ether with the unsaturated carboxylic acid.

(1) G3: prepared by the reaction of acrylic acid with amino-poly (ethylene oxide -propylene oxide) monomethyl ether (number average molecular weight of 2000, m/(m+n)=0.3, from Huntsman).

Acrylic acid (7.56 g, 0.105 mol) and amino poly (ethylene oxide-propylene oxide) monomethyl ether (number average molecular weight of 2000, 200 g, 0.1 mol) were dissolved in 1000 mL of dichloromethane, DMAP (0.122 g, 1 mmol) was then added thereto, and a solution of DCC (22.67 g, 0.1 mol) dissolved in dichloromethane (200 mL) was dropwise added thereto at room temperature for 4 h, then continued to stir for 6 h, filtered to remove white solid precipitate, vacuum distillated, a resulting paste solid was dissolved with dichloromethane, and then precipitated by diethyl ether, centrifugated, and then the resulting paste solid were precipitated by dichloromethane/diethyl ether twice, A final product was dried under vacuum to obtain monomer G3 with a yield of 83%.

(2) G6: prepared by the reaction of methacrylic acid with amino polyethylene glycol (O-(2-aminoethyl) polyethylene glycol, number average molecular weight of 5000, number of ethylene glycol repeat unit being about 113, from Sigma).

Methacrylic acid (0.0903 g, 0.00105 mol) and the above aminopolyethylene glycol (5 g, 0.01 mol) were dissolved in 50 mL of methylene chloride, DMAP (0.00122 g, 0.01 mmol) was added thereto, and a solution of DCC (0.2267 g, 0.01 mol) dissolved in methylene chloride (5 mL) was dropwise added thereto at room temperature for 12 h, white precipitate appeared in the system, after dropwise adding, the system continued to stir for 12 h, filtered, and distilled under reduced pressure. A resulting solid was dissolved with methylene chloride, then precipitated by diethyl ether, filtered, and then the resulting solid was precipitated by methylene chloride/diethyl ether twice. A final product was dried under vacuum to obtain polyether G6 with a yield of 77%.

Following are the specific steps of Examples (measurement of all the reactions below is based on terminal alkenylamine B, and the amount of substance converted to terminal alkenylamine B is 0.1 part by molar, and the amount of feed in following Examples is part by mass). The molecular weight of the product is tested by Shimadzu GPC (LC-20A), and a gel column is TSK-GELSW series of TOSOH Company. A differential refractive detector was used, a flowing phase was 0.1 M NaNO₃ aqueous solution, and polyethylene glycol was used as a reference for molecular weight determination.

### Example 1

(1) Dimethyl sulfoxide (82.48 parts) was added to a reactor, B1 (7.112 parts), C1 (22.52 parts) and concentrated sulfuric acid (20 parts, 98%) were added thereto in sequence, the reactor was regulated to 70° C., stirred uniformly for 1 h, regulated to 120° C., and phosphorous acid (20.5 parts) and polyphosphoric acid (85%P₂O₅ equivalent, 51.95 parts) were added thereto, and the reaction was continued to be stirred for 12h. After the reaction was stopped, the solvent was removed by vacuum to obtain an intermediate mixture.

(2) Water (60 parts), polyether G1 (400 parts) and the intermediate mixture prepared by step (1) were added to a flask, the reactor was regulated to a temperature of 70° C., stirred to mix evenly, and 0.462 parts of azo-diisobutylonitrile powder was added once, and then an aqueous solution (water, 67.98 parts) of methacrylic acid (4.3 parts) and sodium acrylate (4.7 parts) was uniformly dripped thereto for 4h. Starting from dripping of the monomer, 0.462 part of azo-diisobutylonitrilene powder was added thereto every half hour, a total of 8 batches were added. After feeding, the reaction continued for 4 h, and the temperature was regulated to room temperature to stop the reaction. A superplasticizer sample PCE-MP01 was obtained with a weight average molecular weight of 43.2 kDa.

### Example 2

(1) Water (11.03 parts) was added to a reactor, B2 (16.93 parts), C2 (30.03 parts) and concentrated sulfuric acid (5 parts, 98%) were added thereto in sequence, the reactor was regulated to 100° C., stirred uniformly for 6 h, regulated to 60° C., and phosphorous acid (16.4 parts), P₂O₅ (47.33 parts) and anhydrous phosphoric acid (32.67 parts) were added thereto, and the reaction was continued to stir for 10 h. After the reaction was stopped, the solvent was removed by vacuum to obtain an intermediate mixture.

(2) Water (122.72 parts), polyether G2 (240 parts) and the intermediate mixture prepared in step (1) were added to a flask, the reactor was regulated to a temperature of 50° C., stirred to mix evenly, an aqueous solution of the initiator azo-diisobutyamidine hydrochloride (10.27 parts dissolved in 122.72 parts of water) was uniformly dripped thereto for 6 h. After the dripping, the reaction was continued for 12 h, the temperature was regulated to room temperature. After the reaction was stopped, a superplasticizer sample PCE-MP02 was obtained with a weight average molecular weight of 9.8 kDa.

### Example 3

(1) N,N-dimethyl formamide (84.02 parts) was added to a reactor, B3 (9.356 parts), C3 (57.05 parts) and trifluoroacetic acid (11.402 parts) were added thereto in sequence, the reactor was regulated to 100° C., stirred uniformly for 6 h, regulated to 80° C., phosphorous acid (8.2 parts), potassium hypophosphite (10.4 parts), phosphorus penoxide (12.62 parts) and water (1.6 parts) were added thereto, and the reaction was continued to stir for 12 h. After the reaction was stopped, the solvent was removed by vacuum to obtain an intermediate mixture.

(2) Water (185.66 parts), polyether G3 (400 parts) and the intermediate mixture prepared in step (1) were added to a flask, the reactor was regulated to a temperature of 60° C., stirred to mix evenly. At the same time, a mixture of acrylic acid (57.6 parts) and mercaptopropionic acid (1.06 parts) and an aqueous solution of initiator (2.28 parts of ammonium persulfate dissolved in 92.83 parts of water, 4.16 parts sodium bisulfite dissolved in 92.83 parts of water) were uniformly dripped thereto for 5 h, and the reaction continued for 1h after the dripping was completed. The temperature was regulated to room temperature. After the reaction was stopped, a superplasticizer sample PCE-MP03 was obtained with a weight average molecular weight of 45.6 kDa.

### Example 4

(1) N,N-dimethylacetamide (49.28 parts) was added to a reactor, B4 (11.32 parts), C4 (14.42 parts) and methylsulfonic acid (11.533 parts) were added thereto in sequence, the reactor was regulated to 70° C., stirred uniformly for 3 h, regulated to 100° C., hypophosphorous acid (6.6 parts), phosphorus penoxide (6.6 parts) and pyrophosphoric acid (28.48 parts) were added thereto, and the reaction was continued to stir for 4 h. After the reaction was stopped, the solvent was removed by vacuum to obtain an intermediate mixture.

(2) Water (300 parts), polyether G4 (307.5 parts) and the intermediate mixture prepared in step (1) were added to a flask, the reactor was regulated to a temperature of 40° C., an aqueous solution of hydrogen peroxide (30 wt%, 1.13 parts) was added thereto, stirred to mix evenly. At the same time, a mixture of methacrylic acid (21.5 parts) and mercaptoethanol (0.585 part) and an aqueous solution of ascorbic acid (0.88 part dissolved in 98.75 parts of water) were uniformly dripped thereto for 45 min, and the reaction continued for 15 min after the dripping was completed. The temperature was regulated to room temperature. After the reaction was stopped, a superplasticizer sample PCE-MP04 was obtained with a weight average molecular weight of 33.8 kDa.

### Example 5

(1) Water (3.864 parts) was added to a reactor, B5 (9.917 parts), C5 (30.41 parts) and ammonium bisulfate (11.511 parts) were added thereto in sequence, the reactor was regulated to 100° C., stirred uniformly for 3 h, regulated to 90° C., phosphorous acid (8.2 parts), hypophosphorous acid (6.6 parts), phosphorus pentoxide (14.2 parts) and pyrophosphoric acid (17.8 parts) were added thereto, and the reaction was continued to be stirred for 6 h. After the reaction was stopped, the solvent was removed by vacuum to obtain an intermediate mixture.

(2) Water (300.43 parts), polyether G5 (300 parts) and the intermediate mixture prepared by step (1) were added to a flask, the reactor was regulated to a temperature of 45° C., an aqueous solution of hydrogen peroxide (30 wt%, 1.13 parts) and ferrous sulfate (0.0695 part) were added thereto, stirred to mix evenly. At the same time, a mixture of acrylic acid (3.6 parts) and ethanthiol (0.232 part) and an aqueous solution of ascorbic acid (0.44 part dissolved in 100 parts of water) were uniformly dripped to the mixture for 2 h, and the reaction continued for 1 h after the dripping was completed. The temperature was regulated to room temperature. After the reaction was stopped, a superplasticizer sample PCE-MP05 was obtained with a weight average molecular weight of 29.1 kDa.

### Example 6

(1) N-methylpyrrolidone (37.24 parts) was added to a reactor, B6 (11.916 parts), C6 (43.14 parts) and sulfuric acid (5 parts, 98%) were added thereto in sequence, the reactor was regulated to 100° C., stirred uniformly for 6 h, regulated to 90° C., potassium dihydrogen phosphite (12.0 parts), phosphorous acid (16.4 parts), phosphorus penoxide (52.59 parts) and anhydrous phosphoric acid (36.3 parts) were added thereto, and the reaction was continued to stir for 6 h. After the reaction was stopped, the solvent was removed by vacuum to obtain an intermediate mixture.

(2) Water (677.41 parts), polyether G6 (505 parts) and the intermediate mixture prepared by step (1) were added to a flask, the reactor was regulated to a temperature of 35° C., stirred to mix evenly, 1.034 parts of azo-diisobutyimidazoline hydrochloride was added thereto once, the reaction continued for 12 h, the temperature was regulated to room temperature. After the reaction was stopped, a superplasticizer sample PCE-MP06 was obtained with a weight average molecular weight of 97.8 kDa.

### Example 7

(1) B1 (7.112 parts), C1 (18.02 parts) and hydrochloric acid (20 parts, 36.5% of aqueous solution, water directly acting as a reaction solvent) were added thereto in sequence, the reactor was regulated to 80° C., stirred uniformly for 4 h, regulated to 100° C., phosphorous acid (32.8 parts) and pyrophosphoric acid (71.2 parts) were added thereto, and the reaction was continued to be stirred for 4 h. After the reaction was stopped, the solvent was removed by vacuum to obtain an intermediate mixture.

(2) Water (312.26 parts) and the intermediate mixture prepared in step (1) were added to a flask, the reactor was regulated to a temperature of 45° C., hydrogen peroxide (30% aqueous solution, 0.227 part) was added thereto, stirred to mix evenly, a mixture solution(dissolved in 312.26 parts of water) of polyether G1 (250 parts), acrylic acid (21.6 parts), itaconic acid (13 parts), mercaptopropionic acid (6.36 parts) and ascorbic acid (0.44 part) was continuously uniformly added thereto. A cumulative feeding time was 4 h, and the reaction continued for 1 h after the addition was completed. The temperature was regulated to room temperature. After the reaction was stopped, a superplasticizer sample PCE-MP07 was obtained with a weight average molecular weight of 5.2 kDa.

### Example 8

(1) 4.58 parts of water were added to a reactor, then B1 (7.112 parts), C2 (36.03 parts) and p-toluenesulfonic acid (17.22 parts) were added thereto in sequence, the reactor was regulated to 80° C., stirred uniformly for 4 h, regulated to 100° C., potassium dihydrogen phosphite (24.0 parts), phosphorus penoxide (56.8 parts) and water (7.2 parts) were added thereto, the reaction was continued to stir for 4 h. After the reaction was stopped, the solvent was removed by vacuum to obtain an intermediate mixture.

(2) Water (317.68 parts) and the intermediate mixture prepared in step (1) were added to a flask, the reactor was regulated to a temperature of 60° C., ammonium persulfate (2.28 parts) was added thereto once, stirred to mix evenly, a mixed solution (dissolved in 1000 parts of water) of polyether G4 (1845 parts), mercaptopropionic acid (2.12 parts) and ascorbic acid (1.76 parts) was continuously and uniformly added thereto, and a cumulative feeding time was 4 h, and the reaction continued for 2 h after the addition was completed. The temperature was regulated to room temperature. After the reaction was stopped, a superplasticizer sample PCE-MP08 was obtained with a weight average molecular weight of 25.1 kDa.

### Example 9

(1) 48.45 parts of N,N-dimethyl formamide were added to the reactor, and then B3 (9.356 parts), C2 (40.04 parts) and sulfuric acid (15 parts, 98%) were added thereto in sequence. The reactor was regulated to 80° C., stirred uniformly to react for 2 h. Phosphorous acid (24.6 parts) and polyphosphoric acid (115.45 parts, P₂O₅ equivalent amount 85%) were added thereto, and the reaction was continued to be stirred for 6 h. After the reaction was stopped, the solvent was removed by vacuum to obtain an intermediate mixture.

(2) Water (1000 parts) and polyether G2 (720 parts) were added to a flask, the reactor was regulated to a temperature of 75° C., ammonium persulfate (2.11 parts) was added thereto once, stirred to mix evenly, a mixed solution (dissolved in 382.49 parts of water) of the intermediate mixture, acrylic acid (5.76 parts), maleic anhydride (1.96 parts) and thioglycoacetic acid (0.552 part) prepared in step (1) was continuously and uniformly added thereto. A cumulative feeding time was 3 h. Within 3 h, the remaining ammonium persulfate was added in 6 batches. 2.11 parts was added to the reaction system every half hour, the reaction continued for 5 h after the addition was completed. The temperature was regulated to room temperature. After the reaction was stopped, a superplasticizer sample PCE-MP09 was obtained with a weight average molecular weight of 47.1 kDa.

### Example 10

(1) 39.81 parts of N,N-dimethyl formamide were added to a reactor, and then B4 (11.32 parts), C2 (18.02 parts) and trifluoroacetic acid (6.84 parts) were added thereto in sequence. The reactor was regulated to 120° C., stirred uniformly to react for 12 h. Phosphorous acid (1.64 parts), sodium hypophosphite (7.04 parts) and polyphosphoric acid (10.39 parts, P₂O₅ equivalent amount 85%) were added thereto, the reaction was continued to stir for 12 h. After the reaction was stopped, the solvent was removed by vacuum to obtain an intermediate mixture.

(2) Water (57.2 parts) was added to a flask, the reactor was regulated to a temperature of 5° C., hydrogen peroxide (30% aqueous solution, 0.567 part) was added thereto once, stirred to mix evenly. A mixed solution (dissolved in 171.59 parts of water) of intermediate mixture prepared in step (1), polyether G4 (256.25 parts), rongalite (0.193 part) and mercaptoethanol (1.95 part) was continuously and uniformly added thereto. A feeding time lasted for 2 h, and the reaction continued for 1 h after the addition was completed. The temperature was regulated to room temperature. After the reaction was stopped, a superplasticizer sample PCE-MP10 was obtained with a weight average molecular weight of 11.4 kDa.

### Example 11

(1) 13.82 parts of dimethyl sulfoxide was added to a reactor, then B5 (9.917 parts), C5 (33.79 parts) and ammonium bisulfate (6.91 parts) were added thereto in sequence, the reactor was regulated to 80° C., stirred uniformly to react for 4 h. The reactor was regulated to 90° C., and phosphite (8.2 parts), sodium hypophosphite (4.4 parts) and polyphosphoric acid (27.71 parts, P₂O₅ equivalent amount 85%) were added thereto. The reaction was continued to stir for 12 h. After the reaction was stopped, the solvent was removed by vacuum to obtain an intermediate mixture.

(2) Water (628.31 parts), polyether G2 (240 parts) and the intermediate mixture prepared in step (1) were added to a flask, then hydrogen peroxide (0.283 part, 30 wt%) and ferrous ammonium sulfate (0.002085 part) were added thereto, stirred to mix evenly, the reactor was regulated to a temperature of 40° C. A mixed solution of acrylic acid (0.72 parts), itaconic acid (5.2 parts) and mercaptoethanol (0.156 part) (dissolved in 78.54 parts of water) was continuously and uniformly added thereto within 2.5 h. At the same time, an aqueous solution of ascorbic acid (0.132 part of ascorbic acid dissolved in 78.54 parts of water) was continuously and uniformly added into the solution within 3 h, and the reaction continued for 1h after the addition was completed. The temperature was regulated to room temperature. After the reaction was stopped, a superplasticizer sample PCE-MP11 was obtained with a weight average molecular weight of 55.2 kDa.

### Example 12

(1) 16.92 parts of N,N-dimethyl formamide were added to the reactor, and then B6 (11.916 parts), C1 (20.02 parts) and hydrochloric acid (24 parts, 36.5 wt% of aqueous solution) were added thereto in sequence. The reactor was regulated to 80° C., and stirred uniformly to react for 2 h. The reactor was regulated to 120° C. Phosphorous acid (24.6 parts) and polyphosphoric acid (27.71 parts, P₂O₅ equivalent amount 85%) were added thereto, and the reaction was continued to be stirred for 1 h. After the reaction was stopped, the solvent was removed by vacuum to obtain an intermediate mixture.

(2) Water (100 parts), polyether G2 (300 parts) and the intermediate mixture prepared in step (1) were added to a flask, stirred to mix evenly, the reactor was regulated to a temperature of 90° C. A mixed solution of acrylic acid (1.8 parts), ascorbic acid (0.44 part) and mercaptopropionic acid (0.159 part) (dissolved in 155.59 parts of water) was continuously and uniformly added thereto, and an aqueous sodium persulfate solution (1.19 parts of ascorbic acid dissolved in 155.59 parts of water) was continuously and uniformly added thereto. A feeding time was 1 h, and the reaction continued for 1 h after the addition was completed. The temperature was regulated to room temperature. After the reaction was stopped, a superplasticizer sample PCE-MP12 was obtained with a weight average molecular weight of 76.1 kDa.

### Application Examples

The use effect of the superplasticizer described in present application is illustrated by experiments of cement net slurry with an ultra-low water-binder ratio and the ultra-high performance concretes, respectively.

Conch cement (P•O•42.5) was used for a net slurry, Jiangnanxiaoyetian cement (P•II•52.5) was used for a concrete, Aiken 97 silica fume was used for silica fume, and S95 mineral powder was used for mineral powder. All materials were kept constant temperature at the required temperature before the experiments. The comparison samples were a conventional commercial polycarboxylate superplasticizer (commercial 1 is ester type, commercial 2 is ether type, side chain length is 2400). It should be noted that all percentages expressed below are compared with commercial sample having better indicators.

### Cement Net Slurry

According to GB/T8077-2000 “Concrete admixture uniformity test method”, the fluidity of cement net slurry was measured, all amount of dispersant were the percentage of pure solid relative to the mass of cement (wt%). To characterize the dispersion/dispersion retention properties of the samples with ultra-low water-binder ratios, the cement net slurry was prepared using 270 g of cement and 30 g of silica fume, in which a fixed water consumption amount is 51 g. Cement and silica fume are pre-mixed by a mixer to ensure uniform mixing.

Based on the standard slurry stirring process, the net slurry fluidity of different superplasticizers was tested, and the fluidity of cement net slurry was tested after placed for 30 min. The samples prepared in the Examples with the commercial polycarboxylate superplasticizer samples were compared to obtain following results.

TABLE 2

Test results of cement net slurry (20° C.)

| Sample | Amount | fluidity of net slurry (mm) | |
|---|---|---|---|
| | (wt%) | 4 min | 30 min |
| PCE-MP01 | 0.6 | 224 | 232 |
| PCE-MP02 | 0.6 | 290 | 280 |
| PCE-MP03 | 0.6 | 254 | 248 |
| PCE-MP04 | 0.6 | 266 | 258 |
| PCE-MP05 | 0.6 | 289 | 281 |
| PCE-MP06 | 0.6 | 280 | 270 |
| PCE-MP07 | 0.6 | 237 | 242 |
| PCE-MP08 | 0.6 | 296 | 302 |
| PCE-MP09 | 0.6 | 292 | 286 |
| PCE-MP10 | 0.6 | 260 | 251 |
| PCE-MP11 | 0.6 | 277 | 265 |
| PCE-MP12 | 0.6 | 284 | 277 |
| Commercial 1 | 0.6 | 190 | 154 |
| Commercial 2 | 0.6 | 170 | 162 |

It can be seen from the results in Table 2, although the dispersion ability of the superplasticizer prepared in the Examples of the present application, with high or low, is related to the structural parameters, compared with the commercial samples, their dispersion ability were much better at the condition of 0.17 of water-binder ratio. Except PCE-MP01 and PCE-MP07, the fluidity retention ability of most samples is basically equivalent to that of commercial sample 2, and much better than that of commercial sample 1.

### Ultra-High Performance Concrete (UHPC) Test (Dispersion Performance Comparison, Mortar)

In order to investigate the maximum dispersion ability of different samples under different amounts, the fluidity of cement mortar under the condition of ultra-low water-binder ratio was investigated under the given matching ratio.

TABLE 3

Formulation ratio of UHPC mortar (weight ratio)

| Cement | Silica fume | Ultrafine mineral powder | Sand | Water |
|---|---|---|---|---|
| 0.60 | 0.12 | 0.28 | 0.7 | 0.15 |

The shear viscosity of the mortar with an initial fluidity of (240±5)mm was investigated. A rheological curve of the initial slurry was measured by a Rheometer (Brookfield R/S300 Rheometer) (refer to Constr. Build. Mater. 2017, 149, 359-366. The maximum shear rate is 25 s⁻¹), and the shear viscosity of 15 s⁻¹ is selected for comparison (this shear rate is at the same level as the rate of slurry treatment such as stirring and mixing). At the same time, V funnel time of the mortar with this fluidity was measured, and the results are shown in Table 4.

TABLE 4

Test results of UHPC mortar (20° C., the control is not tested)

| Sample | mortar fluidity (mm) under different amounts (wt%) | | | | | | V funnel time | 15 s⁻¹ shear viscosity |
|---|---|---|---|---|---|---|---|---|
| | 0.4 | 0.5 | 0.6 | 0.7 | 0.8 | 0.9 | (s) | (Pa·s) |
| PCE-MP01 | | 239 | 262 | 266 | 264 | 265 | 27 | 21.5 |
| PCE-MP02 | 243 | 277 | 306 | 308 | 306 | 305 | 26.7 | 21.0 |
| PCE-MP03 | | 244 | 266 | 283 | 288 | 286 | 27.3 | 22.1 |
| PCE-MP04 | | 245 | 271 | 279 | 280 | 279 | 24.8 | 19.9 |
| PCE-MP05 | 242 | 271 | 300 | 320 | 325 | 322 | 26 | 19.4 |
| PCE-MP06 | 238 | 262 | 277 | 295 | 293 | 290 | 29.6 | 22.9 |
| PCE-MP07 | | 242 | 265 | 270 | 268 | 266 | 24.3 | 18.5 |
| PCE-MP08 | 237 | 274 | 305 | 317 | 322 | 320 | 24.2 | 20.0 |
| PCE-MP09 | 245 | 279 | 310 | 319 | 319 | 317 | 28.1 | 20.7 |
| PCE-MP10 | | 245 | 270 | 278 | 277 | 275 | 23.9 | 17.5 |
| PCE-MP11 | 235 | 262 | 278 | 292 | 290 | 292 | 27.7 | 22.2 |
| PCE-MP12 | 238 | 264 | 282 | 300 | 301 | 299 | 27.9 | 22.4 |
| Commercial 1 | | 221 | 242 | 239 | 235 | 230 | 34.5 | 28.2 |
| Commercial 2 | | 200 | 230 | 237 | 232 | 228 | 41 | 30.5 |

It can be seen from the results in Table 4 that under the condition of the tested matching ratios, all the samples showed a trend of increasing the mortar fluidity first and then no longer increasing with the increase of the amount, while the fluidity of some samples decreased slightly with the increase of the amount, because the viscosity is increased, the flow rate slowed down, and the fluidity was slightly smaller during the measurement time. The maximum fluidity shown in the table is regarded as the limit water reduction of the sample, that is, the maximum dispersion degree can be achieved regardless of the sample amounts.

The maximum dispersion ability of all samples in the table is much greater than that of the commercial samples, which indicates the super dispersion ability of the samples prepared by Examples of the present application. In addition, even if comparing the amounts when the mortar fluidity reaches 240 mm, the required amount of the samples of Examples of the present application is 0.1 wt% to 0.2 wt% lower than that of the commercial sample (corresponding to a percentage reduction of 16% to 42%).

The shear viscosity (15 s⁻¹) and V funnel time of the mortar at the fluidity of (240±5) mm were compared, the sample PCE-MP01-12 prepared in Example of the present application can reduce the shear viscosity by 17% to 42% and the V funnel time by 14% to 40%, which fully illustrates the viscosity reducing characteristics of the sample.

(3) Ultra-high performance concrete (UHPC) test (concrete, including fiber)

To investigate performance of the superplasticizer prepared in the present application applied in UHPC by changing the matching ratio, the concrete matching ratio is as follows.

TABLE 5

UHPC ratio (weight ratio, fiber being volume fraction)

| Cement | Silica fume | Superfine mineral powder | Fly ash | Sand | Fiber/V% | Water |
|---|---|---|---|---|---|---|
| 0.70 | 0.13 | 0.05 | 0.12 | 0.9 | 2 | 0.148 |

Xiaoyetian cement (P II 52.5), the sand is a coventional river sand, the fiber is steel fiber with an L/D ratio of 30 and a length of 50 mm, and the amount (unit: mass percentage, wt%) of superplasticizer PCE-MP01-12, commercial 1 and commercial 2 is calculated by the converting solid amount based on the cementing material, in the test, the slump ((20±1) cm) and expansion degree ((45±2) cm) of UHPC were controlled to be equivalent by adjusting the amount of superplasticizer. The defoaming agent used was a conventional PXP-I concrete defoaming agent sold by Jiangsu Sobute New Material Co., LTD. The gass content of UHPC in each group was basically the same by the defoaming agent. If the concrete fluidity is difficult to reach the above indexes, the fluidity of the superplasticizer at the amount of 1.0 wt% is uniformly investigated, and the fluidity of the concrete under exit from machine is investigated. At this yield, the dispersion ability of the sample has reached the limit, and the concrete fluidity is difficult to be enhanced by increasing the superplasticizer.

The cement, the silica fume, the fly ash and the sand were added to a mixer while stirring for 2 min, then the fiber was added and stirred for 3 min to exit from the machine. The slump and expansion degree of UHPC were tested respectively and recorded as “initial/exit from machine” and the amount of superplasticizer used. The results were as follows.

TABLE 6

UHPC characterization (20° C.)

| Sample | Amount (wt%) | Gas content | Slump/expansion degree(cm) | compressive strength after 28 d |
|---|---|---|---|---|
| | | (%) | exit from machine | (MPa) |
| PCE-MP01 | 1.00 | 1.9 | 18.5/40.0 | 160.8 |
| PCE-MP02 | 0.65 | 1.7 | 20.2/44.0 | 159.7 |
| PCE-MP03 | 0.78 | 1.9 | 19.8/45.5 | 158.0 |
| PCE-MP04 | 0.80 | 2.1 | 20.3/45.0 | 161.4 |
| PCE-MP05 | 0.59 | 2.0 | 21.0/47.0 | 162.3 |
| PCE-MP06 | 0.75 | 2.1 | 20.4/45.0 | 163.0 |
| PCE-MP07 | 0.92 | 1.9 | 19.7/43.5 | 161.2 |
| PCE-MP08 | 0.62 | 1.7 | 20.0/44.0 | 158.8 |
| PCE-MP09 | 0.62 | 2.0 | 20.4/46.5 | 160.2 |
| PCE-MP10 | 0.85 | 1.8 | 19.5/43.0 | 160.4 |
| PCE-MP11 | 0.75 | 1.9 | 20.7/44.0 | 163.3 |
| PCE-MP12 | 0.72 | 2.1 | 20.5/44.0 | 159.2 |
| Commercial 1 | 1.00 | 2.2 | 15.0/- | 150.4 |
| Commercial 2 | 1.00 | 2.0 | 13.4/- | 151.2 |

* “-” indicates only slump without expansion degree

It can be seen that the commercial superplasticizer can no longer meet the fluidity requirements of concrete with such a low water-binder ratio, while the superplasticizer samples prepared by the Examples can give good fluidity to concrete with a water-binder ratio of 0.148. Comparing the compressive strength of concrete after 28 days, the dispersion property of the commercial superplasticizer is not good, and the strength is slightly lower than that of the sample prepared by the Examples, which may be caused by the slightly poor uniformity of the slurry and aggregate.

What is claimed is:

1. A multi-functional group superplasticizer for an ultra-high performance concrete, whereinin its backbone is an alkyl chain, and its side chain are some side chains with carboxylic acid or carboxylate at terminals, some polyether side chains, and some polyol amine side chains substituted with phosphoric acid or phosphite at terminals, the polyol amine side chains substituted with phosphoric acid or phosphite at terminals is connected to the backbone through a phenyl or an alkyl group of 1-9 carbons, and a ratio of a number of the side chains with carboxylic acid or carboxylate at terminals to a total number of side chains is ≥0 and ≤0.8; and a ratio of a number of the polyether side chains to the total number of side chains is ≥0.1 and ≤0.9;
following two structural formulas of the polyol amine side chains substituted with phosphoric acid or phosphite are combined in any proportion: 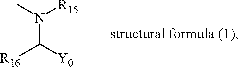 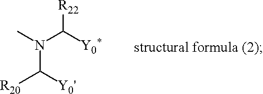
in the structure shown, R₁₅ represents H or a saturated alkyl group containing 1-4 carbon atoms, in a same polymer molecule, R₁₅ can be the same or different in the structure shown in each chain;
in the structure shown, R₁₆, R₂₀ and R₂₂ independently represent —PO₃H₂ or —PO₂H₂;
in the structure shown, Y₀, Y₀’ and Y₀” are product functional groups of the polyols containing hydroxyl group reacting with sufficient or insufficient amount of phosphorylation reagent, such that H of the hydroxyl is substituted with phosphoryl group, and Y₀, Y₀’ and Y₀” are connected to the remaining structure shown in structural formula (2) through a carbon-carbon bond; an original structure of polyol containing hydroxyl may have a carboxyl group or may originally contain a phosphoryl group.

2. The multi-functional group superplasticizer for an ultra-high performance concrete according to claim 1, whereinin Y₀, Y₀’ and Y₀” in the structure shown are alkyl polyol residues connected with carboxyl, carboxylate, phosphoryl or phosphate functional group at terminals; or alkyl polyol residues substituted in part or in whole with carboxyl, carboxylate, phosphoryl or phosphate functional groups; and carboxyl group replaces the position of H atom of C—H bond, and the phosphoryl group replaces the position of H of C—H bond or hydroxyl group; hydroxyl group of the polyol is substituted with phosphoryl to form a structure of —O—PO₃H₂.

3. The multi-functional group superplasticizer for an ultra-high performance concrete according to claim 1, whereinin Y₀, Y₀’ and Y₀” in the structure shown independently represent any one or more of the structure shown in following general formula (3), in a same polymer molecule, Y₀, Y₀’ and Y₀” in the structures shown by each chain can be the same or different respectively, wherein chirality of all carbon atoms can be arbitrary: 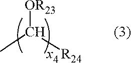
wherein R₂₃ represents H or —PO₃H₂ or any one or more of functional groups shown in general Formula (4) below, R₂₄ represents H or —CH₂OPO₃H₂ or —COOH or —COONa or —COOK or —CH₂OPO₃Na₂ or —CH₂OPO₃K₂, x₄ represents a positive integer between 2-6, and comprising 2 and 6; each of Y₀, Y₀’ and Y₀” functional groups can respectively have at most one functional group as shown in general Formula (4), 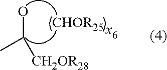
wherein R₂₅ and R₂₆ independently represent H or —PO₃H₂, and x₆ represents positive integers between 1 and 4, and comprising 1 and 4.

4. The multi-functional group superplasticizer for an ultra-high performance concrete according to claim 1, whereinin the side chain with carboxylic acid or carboxylate at terminals is any one of following structural formulas: 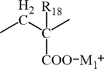 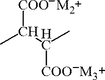 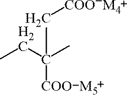
structural formula (5), structural formula (6), structural formula (7); wherein R₁₈ represents H or methyl,
M1⁺, M2⁺, M3⁺, M4⁺, and M5⁺ independently represent H⁺ or NH4⁺ or Na⁺ or K⁺, respectively, and
the polyether segment is connected to the backbone by carbonyl, phenyl, —OCH₂CH₂—, —OCH₂CH₂CH₂—, —CO—NH—CH₂CH₂ —, or —(CH₂)ₚₚ—, wherein pp is an integer between 1 and 6, and comprising 1 and 6.

5. The multi-functional group superplasticizer for an ultra-high performance concrete according to claim 1, whereinin the multi-functional group superplasticizer is a comb polymer having a structure shown in following general formula (8), in which chirality of all carbon atoms is not limited: 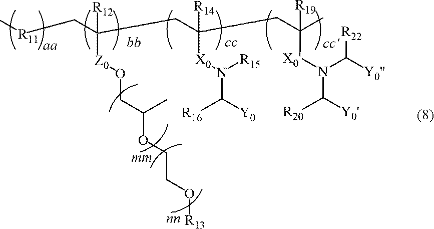
in the structure shown, an average number of R₁₁ segment is aa;
in the structure shown, R₁₂, R₁₃, R₁₄ and R₁₉ independently represent —H or methyl, respectively;
in the structure shown, Z₀ represents carbonyl or phenyl or —OCH₂CH₂— or —OCH₂CH₂CH₂CH₂— or —CO—NH—CH₂CH₂ — or —(CH₂)ₚₚ—, wherein pp is an integer between 1 and 6, and comprising 1 and 6;
in the structure shown, mm and nn represent a number of repeat units of isopropoxy and ethoxy, respectively, which can be an integer or not, a value of (mm+nn) ranges from 8 to 114, and mm/(mm+nn) is not greater than ½, the structure shown in general formula (0) does not limit a connection order of ethoxy and isopropoxy repeat units, which can be block or random;
in the structure shown, X₀ and X₀’ independently represent saturated alkyl containing 1-9 carbon atoms or phenyl groups, respectively;
R₁₅ represents H or a saturated alkyl group containing 1-4 carbon atoms, in a same polymer molecule, R₁₅ can be the same or different in the structure shown by each chain;
in the structure shown, R₁₆, R₂₀ and R₂₂ independently represent —PO₃H₂ or —PO₂H₂ or the corresponding sodium salt and potassium salt, respectively; and
in the structure shown, aa, bb, cc and cc′ respectively represent an average of the corresponding chains of the polymer, and a ratio of cc to cc′ is arbitrary, the values of aa, bb, cc and cc′ should meet following conditions: (1) 0≤aa/(aa+bb+cc+cc′)≤0.8; (2) 0.1≤bb/(aa+bb+cc+cc′)≤0.9; and (3) a weight average molecular weight of the superplasticizer polymer ranges from 2000 to 100000.

6. A method for preparing the multi-functional group superplasticizer for an ultra-high performance concrete according to claim 1, comprising:
copolymerizing terminal alkenylamine B, polyhydroxyaldehyde C and phosphorous-containing composition E under an environment of solvent A and the action of acid catalyst D, to obtain an intermediate, and free radical polymerizing with unsaturated carboxylic acid F and unsaturated polyether G in aqueous solution to produce the multi-functional group superplasticizer for an ultra-high performance concrete;
whereinin the solvent A is any one of water, dimethyl sulfoxide, N,N-dimethyl formamide, N,N-dimethyl acetamide, N-methyl pyrrolidone, and dioxane, or a mixture thereof at any proportion;
the terminal alkenylamine B is any one of a structure corresponding to following general formula (9), and corresponding hydrochloride and sulfate, or an arbitrary mixture of more than one thereof: 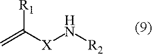
wherein R₁ represents —H or methyl, X represents a saturated alkyl containing 1-9 carbon atoms or phenyl, and R₂ represents H or a saturated alkyl containing 1-4 carbon atoms;
the polyhydroxyaldehyde C is any one of a small molecular sugar with an aldehyde terminal group containing 3-14 carbon atoms, or an organic molecule corresponding to the structure shown in following general Formula (10), or an arbitrary mixture of more than one thereof: 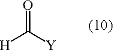
wherein Y represents any one of the structures shown in following general Formula (11), wherein the configuration of any chiral carbon atom is not limited: 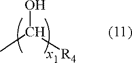
wherein R₄ represents any one of H or —CH₂OPO₃H₂ or —COOH or —COONa or —COOK or —CH₂OPO₃Na₂ or —CH₂OPO₃K₂ or following structures shown in general Formula (12); 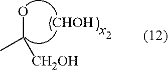
x₁ is a positive integer between 2 and 6, and comprising 2 and 6; x₂ represents a positive integer between 1 and 4, and comprising 1 and 4;
the acid catalyst D is a strong acid, comprising but not limited to any one of p-toluene sulfonic acid, hydrochloric acid, sulfuric acid, trifluoroacetic acid, methyl sulfonic acid, trifluoromethanesulfonic acid, sodium bisulfate, potassium bisulfate and ammonium bisulfate;
the phosphorous-containing composition E is a mixture of component I and component J, wherein the component I is one of phosphorous acid, potassium dihydrogen phosphite, sodium dihydrogen phosphite, hypophosphorous acid, sodium hypophosphite and potassium hypophosphite, or an arbitrary mixture of more than one thereof, and component J is one of phosphoric acid, polyphosphate, pyrophosphoric acid, phosphorus penoxide and water, or a mixture of more than one thereof;
the component I is reacted with aldehyde group of B and C; J is reacted with hydroxyl group of C, and amounts of I and J are determined by amount of B and content of hydroxyl group in C;
the unsaturated carboxylic acid F is one of acrylic acid, methacrylic acid, maleic acid, fumaric acid, maleic anhydride, fumaric anhydride, itaconic acid or corresponding sodium, potassium and ammonium salts thereof, or a mixture of more than one thereof;
the unsaturated polyether G is one or a combination of more than one of the structures shown in following general Formula (13) 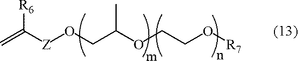
wherein R₆ and R₇ independently represent —H or methyl, Z represents carbonyl, phenyl, —OCH₂CH₂—, —OCH₂CH₂CH₂—, —CO—NH—CH₂CH₂ —, or —(CH₂)ₚ—, wherein p is an integer between 1 and 6, and comprising 1 and 6; and
m and n represent a number of repeated units of isopropoxyl and ethoxyl, respectively, which can be an integer or not, values of (m+n) ranges from 8 to 114, and m/(m+n) is not greater than ½, the structure shown in general formula (13) does not limit a connection order of ethoxy and isopropoxy repeat units, which can be block or random.

7. The method according to claim 6, whereinin an initiator H used by the free radical polymerization is a heat-initiated or redox initiator, and the initiator can be added at a time or continuously and uniformly within a certain period of time, the initiator comprises initiator systems listed below:
the heat initiator is any one of azo-diisobutyronitrile, azodiisoheptanitrile, azo-diisobutyamidine hydrochloride, azo-diisobutyimidazoline hydrochloride, ammonium persulfate, potassium persulfate and sodium persulfate;
the redox initiator is composed of an oxidizing agent and a reducing agent, and the oxidizing agent is any one of hydrogen peroxide, ammonium persulfate, potassium persulfate and sodium persulfate;
when the oxidizing agent is hydrogen peroxide, the reducing agent is one or an arbitrary combination of more than one of saturated alkyl thiol containing 2-6 carbon atoms, thioglycolic acid, ascorbic acid or mercaptopropionic acid. In addition, one or an arbitrary combination of more than one of ferrous acetate, ferrous sulfate or ammonium ferrous sulfate can be comprised or not as a catalyst, which is measured by a molar amount of Fe element, the amount of the catalyst is not greater than 10% of the molar amount of the reducing agent;
when the oxidizing agent is any one of ammonium persulfate, potassium persulfate and sodium persulfate, the reducing agent is any one of following compositions: (1) one or an arbitrary combination of more than one of thioglycolic acid, ascorbic acid, rongalite or mercaptopropionic acid, in addition, one or an arbitrary combination of more than one of ferrous acetate, ferrous sulfate or ammonium ferrous sulfate can be comprised or not as a catalyst, which is measured by a molar amount of Fe element, the amount of the catalyst is not greater than 10% of the molar amount of the reducing agent; (2) one or an arbitrary combination of more than one of sodium bisulfite, sodium sulfite and sodium metabisulfite; and
the amount of initiator is calculated based on following method, if the initiator is a thermal initiator, a mass of the initiator accounts for 0.2% to 4% of a total mass of terminal alkenylamine B, unsaturated carboxylic acid F and unsaturated polyether G; and if the initiator is a redox initiator, by calculating with the one which having more molar amount of oxidant and reductant, a molar amount of the initiator accounts for 0.2% to 4% of a total molar amount of terminal alkenylamine B, unsaturated carboxylic acid F and unsaturated polyether G, and a molar ratio of the oxidizing agent and the reducing agent is 0.25 to 4.

8. The method according to claim 6, whereinin a chain transfer agent K comprises: (1) an organic small molecule containing a sulfhydryl, which comprises a saturated alkyl sulfhydryl containing 2-6 carbon atoms, mercaptoethanol, mercaptoethylamine, cysteine, mercaptoacetic acid or mercaptopropionic acid; (2) sodium bisulfite, sodium sulfite and sodium metabisulfite; an amount of them is 0.1% to 15% of a total molar amount of polymerizable double bonds in a reaction system; the total molar amount of the polymerizable double bond is numerically equivalent to a total molar amount of the terminal alkenylamine B, the polyether G and the unsaturated carboxylic acid F.

9. The method according to claim 6, comprising following steps:
(1) adding solvent A to a reactor, and adding terminal alkenylamine B, polyhydroxyaldehyde C, and acid catalyst D in sequence, adjusting the reactor to 70° C. to 120° C., stirring uniformly and reacting for 1 h to 12 h, adjusting the reactor to 60° C. to 120° C., adding phosphorus-containing composition E, stirring for 1 h to 12 h, and finishing reaction, and removing the solvent by vacuum to obtain an intermediate mixture; and
(2) radical polymerizing whole intermediate mixture prepared in step (1) with the unsaturated carboxylic acid F and the unsaturated polyether G in aqueous solution under 0° C. to 90° C. to prepare the multi-functional group superplasticizer.

10. The method according to claim 9, whereinin an effective reactant in step (1) accounts for 50 to 90% of the total mass of the system, and the effective reactant comprises terminal alkenylamine B, polyhydroxyaldehyde C and phosphorous-containing composition E.

11. The method according to claim 9, whereinin a concentration of the effective reactant in step (2) is 30 wt% to 80 wt%, and the effective reactant is a sum of the intermediate mixture, the polyether G and the unsaturated carboxylic acid F.
